(19) United States
(12) Patent Application Publication
(10) Pub. No.: US 2025/0166139 A1
(43) Pub. Date: May 22, 2025

(54) BLURRY VIDEO REPAIR METHOD AND APPARATUS

(71) Applicant: Beijing Zitiao Network Technology Co., Ltd., Beijing (CN)

(72) Inventor: Hang DONG, Beijing (CN)

(21) Appl. No.: 18/723,398

(22) PCT Filed: Dec. 22, 2022
(86) PCT No.: PCT/CN2022/140997

§ 371 Date: Jun. 21, 2024

(30) Foreign Application Priority Data
Dec. 22, 2021 (CN) 202111580254.1

(51) Int. Cl. G06T 5/73; G06T 3/40; G06T 5/50; G06T 5/60

(52) U.S. Cl. CPC G06T 5/73; G06T 3/40; G06T 5/50; G06T 5/60; G06T 2207/10016; G06T 2207/20084; G06T 2207/20221

(57) ABSTRACT

A blurry video repair method and apparatus relate to the technical field of image processing. The method comprises: performing feature extraction on a target video frame of a video to be repaired, so as to acquire an intrinsic feature of the target video frame; acquiring a forward hidden variable set of the target video frame according to the intrinsic feature and a first hidden variable set; acquiring a backward hidden variable set of the target video frame according to the intrinsic feature and a second hidden variable set; acquiring an enhanced feature of the target video frame according to the intrinsic feature and the forward hidden variable set and backward hidden variable set of the target video frame; and performing additive fusion on the enhanced feature of the target video frame and the target video frame, so as to acquire a deblurred video frame of the target video frame.

### CROSS-REFERENCE TO RELATED APPLICATIONS

The present application is a national phase application of PCT/CN2022/140997 filed Dec. 22, 2022, which claims priority to and is based on a Chinese application with an application number 202111580254.1 and a filing date of Dec. 22, 2021, the above aforementioned applications are hereby incorporated by reference in their entireties.

### FIELD OF THE INVENTION

The invention relates to the field of image processing technology, especially relates to a blurry video repair method and apparatus.

### BACKGROUND

Video deblurring is a kind of classic computer vision task. The main purpose of video deblurring is to repair the blurry video, so as to obtain a clear video. Because in various advanced computer vision tasks (video detection, video identification and so on), it is necessary to firstly deblur the video to obtain clear video, the video deblurring problem has get widespread attention in the field of computer vision.

### DISCLOSURE OF THE INVENTION

In view of this, the present disclosure provides a blurry video repair method and apparatus.

In order to reach the above object, the present disclosure provides technical solutions as follows:

In a first aspect, an embodiment of the present disclosure provides a blurry video repair method, including:
performing feature extraction on a target video frame of a video to be repaired, so as to acquire an intrinsic feature of the target video frame;
acquiring a forward hidden variable set of the target video frame based on the intrinsic feature and a first hidden variable set, wherein the first hidden variable set is the forward hidden variable set of a previous video frame of the target video frame;
acquiring a backward hidden variable set of the target video frame based on the intrinsic feature and a second hidden variable set, wherein the second hidden variable set is the backward hidden variable set of a next video frame of the target video frame;
acquiring an enhanced feature of the target video frame based on the intrinsic feature, the forward hidden variable set of the target video frame, and the backward hidden variable set of the target video frame; and
performing additive fusion on the enhanced feature of the target video frame and the target video frame, so as to acquire a deblurred video frame from the target video frame.

In a second aspect, an embodiment of the present disclosure provides a blurry video repair apparatus, including:
a feature extraction unit configured to perform feature extraction on a target video frame of a video to be repaired, so as to acquire an intrinsic feature of the target video frame;
a forward transfer unit configured to acquire a forward hidden variable set of the target video frame based on the intrinsic feature and a first hidden variable set, wherein the first hidden variable set is the forward hidden variable set of a previous video frame of the target video frame;
a backward transfer unit configured to acquire a backward hidden variable set of the target video frame based on the intrinsic feature and a second hidden variable set, wherein the second hidden variable set is the backward hidden variable set of a next video frame of the target video frame;
a feature processing unit configured to acquire an enhanced feature of the target video frame based on the intrinsic feature, the forward hidden variable set of the target video frame, and the backward hidden variable set of the target video frame; and
an acquisition unit configured to perform additive fusion on the enhanced feature of the target video frame and the target video frame, so as to acquire a deblurred video frame from the target video frame.

In a third aspect, an embodiment of the present disclosure also provides an electronic device, including a processor and a memory for storing a computer program; wherein the processor, when calling the computer program, cause the electronic device to implement the blurry video repair method as described in the first aspect or any alternative implementation in the first aspect.

In a fourth aspect, an embodiment of the present disclosure provides a computer-readable storage medium storing a computer program, which, when executed by a computing device, causes the computing device to implement the blurry video repair method as described in the first aspect or any alternative implementation in the first aspect.

In a fifth aspect, an embodiment of the present disclosure provides a computer program product, which, when running on a computer, cause the computer to implement the blurry video repair method as described in the first aspect or any alternative implementation in the first aspect.

In a sixth aspect, an embodiment of the present disclosure provides a computer program including program codes which, when executed by a computer, cause the computer to implement the blurry video repair method as described in the first aspect or any alternative implementation in the first aspect.

### DESCRIPTION OF THE DRAWINGS

The accompanying drawings, which are incorporated in and constitute a part of the present specification, illustrate embodiments of the present disclosure, and explain the principles of the present disclosure together with the specification.

In order to more clearly illustrate the embodiments of the present disclosure or technical solutions in the prior art, the drawings needed to be used in the description of the embodiments or the prior art will be briefly introduced below, obviously, for those of ordinary skill in the art, other drawings can be obtained based on these drawings without paying any creative labor.

FIG. 1 is a step flowchart illustrating a blurry video repair method provided by an embodiment of the present disclosure;

FIG. 2 is a first one of structural schematic diagrams of a blurry video repair network provided by embodiments of the present disclosure;

FIG. 3 is a second one of structural schematic diagrams of a blurry video repair network provided by embodiments of the present disclosure;

FIG. 4 is a third one of structural schematic diagrams of a blurry video repair network provided by embodiments of the present disclosure;

FIG. 5 is a fourth one of structural schematic diagrams of a blurry video repair network provided by embodiments of the present disclosure;

FIG. 6 is a fifth one of structural schematic diagrams of a blurry video repair network provided by embodiments of the present disclosure;

FIG. 7 is a sixth one of structural schematic diagrams of a blurry video repair network provided by embodiments of the present disclosure;

FIG. 8 is a schematic diagram of a blurry video repair apparatus provided by an embodiment of the present disclosure;

FIG. 9 is a hardware structural schematic diagram of an electronic device provided by an embodiment of the present disclosure.

### DETAILED DESCRIPTION OF PREFERRED EMBODIMENTS

In order to be able to understand the above objects, features and advantages of the present disclosure more clearly, the solutions of the present disclosure will be further described below. It should be noted that the embodiments of the present disclosure and the features in the embodiments can be combined with each other without conflict.

In the following description, numerous specific details are set forth in order to provide a thorough understanding of the present disclosure, but the present disclosure may be practiced in ways other than that as described herein; obviously, the embodiments in the specification are only a part of the embodiments of the present disclosure, but not all of the embodiments.

It should be noted that to facilitate clear description of the technical schemes according to embodiments of the present disclosure, the words “first”, “second”, etc. are employed to distinguish the same or similar items with the substantially same functions and effects in embodiments of the present disclosure, it shall be understood by those skilled in the art that the words “first”, “second”, etc. do not limit the number and the order of execution. For example: a first feature image set and a second feature image set only aim to distinguish different feature image sets, instead of limiting the sequence of the feature image sets.

In embodiments of the present disclosure, words “exemplary” or “for example” and the like are used to represent an example, an illustration or an explanation. Any “exemplary” or “for example” embodiment or design scheme as described in embodiments of the present disclosure should not be construed as being more preferred or more advantageous than other embodiments or design schemes. In particular, usage of words “exemplary” or “for example” and the like aims to present a related concept in a specific manner. In addition, in the description of embodiments of the present disclosure, unless otherwise specified, “a plurality of” may mean two or more.

Compared with a deblurring network for a single-frame image, a video deblurring network in theory can use information about adjacent frames to acquire more detail information, so as to obtain better deblurring effect. In order to obtain better deblurring effect when the video is deblurred, the existing video deblurring network generally utilizes an explicit motion compensation module such as a motion compensation module based on Optical Flow, a motion compensation module based on deformable convolution or the like, to eliminate displacement between adjacent frames caused by camera and background motion, so as to align the same pixel point in the adjacent frames, so that a subsequent multi-frame fusion module can effectively perform information fusion, so as to obtain better deblurring effect. However, although the video deblurring network in theory can utilize information about adjacent frames to obtain more detail information so as to obtain better deblurring effect, since different pixel points in the adjacent frames in a blurry video may have inconsistent blur degrees, which will cause a constraint that the same pixel point in the adjacent frames shall have the same brightness to be seriously broken, and the explicit motion compensation module often cannot accurately predict the displacement of the same pixel point between adjacent frames, the video deblurring network is very liable to obtain wrong information from the adjacent frames, therefore, the deblurring effect of the existing video deblurring network is far from well, even not exceeding the deblurring effect of the deblurring network for the single-frame image.

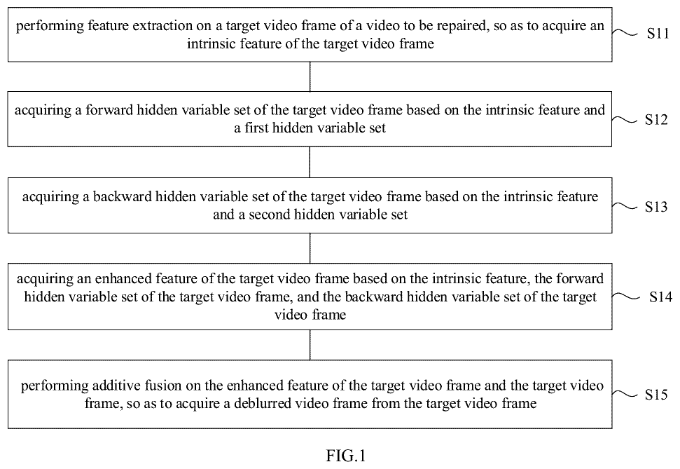

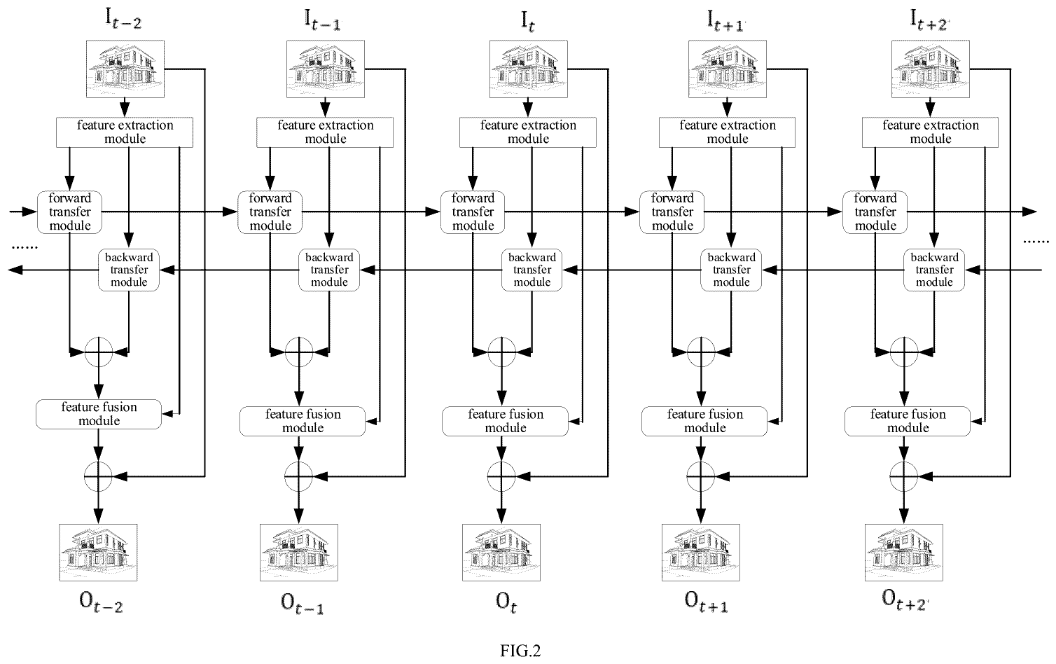

An embodiment of the present disclosure proposes a blurry video repair method, with reference to the step flowchart as shown in FIG. 1 and the structural schematic diagram of a blurry video repair network as shown in FIG. 2, the blurry video repair method provided by an embodiment of the present disclosure includes the following steps:

S11, performing feature extraction on a target video frame of a video to be repaired, so as to acquire an intrinsic feature of the target video frame.

Specifically, the target video frame in the embodiment of the present disclosure may be any one frame in the blurry video to be repaired, each frame in the blurry video to be repaired can be treated as the target video frame in the present disclosure embodiment one by one, so that a blurred video frame for each frame in the blurry video to be repaired can be obtained, thereby obtaining the repair result of the blurry video to be repaired.

As an alternative embodiment of the present disclosure, a manner of implementing the step S11 (performing feature extraction on a target video frame of a video to be repaired, so as to acquire an intrinsic feature of the target video frame) can include the following step a and step b:
step a, processing the target video frame through a convolutional layer, to acquire a convolutional feature of the target video frame.
step b, processing the convolutional feature through a residual block (Res), to acquire the intrinsic feature of the target video frame.

Specifically, the residual block in the present disclosure is also referred to as a Channel Attention Block.

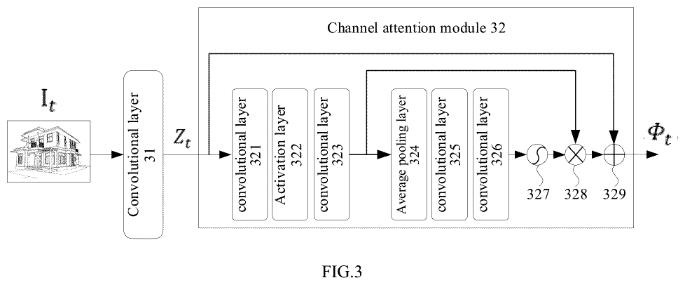

Referring to FIG. 3, a network structure of a feature extraction module implementing the above step S11 includes: a convolutional layer 31 and a channel attention block 32. Wherein, the channel attention block 32 includes: a convolutional layer 321, an activation layer 322, a convolutional layer 323, an average pooling layer 324, a convolutional layer 325, a convolutional layer 326, a normalization unit 327, a multiplicative fusion unit 328, and an additive fusion unit 329. The process of the feature extraction module acquiring the intrinsic feature of the target video frame can include: firstly, inputting a target video frame Iₜ to the convolutional layer 31, and then inputting a convolutional feature Zₜ output by the convolutional layer 31 to the channel attention block 32. The channel attention block 32 firstly processes the convolutional feature Zₜ sequentially through the convolutional layer 321, the activation layer 322, the convolutional layer 323, the average pooling layer 324, the convolutional layer 325, the convolutional layer 326, the normalization unit 327, then performs multiplicative fusion on the output of the normalization unit 327 and the output of the convolutional layer 323 through the multiplicative fusion unit 328, finally performs additive fusion on the output of the multiplying fusion unit 328 and the convolutional feature Zₜ through the additive fusion unit 329, so that the intrinsic feature Φₜ of the target video frame Iₜ can be acquired.

S12, acquiring a forward hidden variable set of the target video frame based on the intrinsic feature and a first hidden variable set.

Where, the first hidden variable set can be the forward hidden variable set of a previous video frame of the target video frame.

Namely, based on the intrinsic feature of the current frame and the forward hidden variable set of the previous video frame, the forward hidden variable set of the current frame can be acquired.

As an alternative embodiment of the present disclosure, the forward hidden variable set may include an encoding feature and a decoding feature under a first scale, an encoding feature and a decoding feature under a second scale, and an encoding feature and a decoding feature under a third scale.

Namely, the forward hidden variable set may include features pairs (the encoding feature and the decoding feature) under three spatial scales.

It should be noted that, on the basis of the above embodiments, the forward hidden variable set in embodiments of the present disclosure may further include feature pairs under other number of spatial scales. For example: the feature pairs under the spatial scales may include feature pairs under two spatial scales, again for example, the feature pairs under the spatial scales may include feature pairs under four spatial scales, which are not limited in embodiments of the present disclosure.

As an alternative embodiment of the present disclosure, on the basis that the forward hidden variable set may include an encoding feature and a decoding feature under a first scale, an encoding feature and a decoding feature under a second scale, and an encoding feature and a decoding feature under a third scale, the steps of implementing the above step S12 (acquiring the forward hidden variable set of the target video frame based on the intrinsic feature and the first hidden variable set) may include the following step 121 to step 127:

Step 121: based on the intrinsic feature, and the encoding feature and the decoding feature under the first scale included in the first hidden variable set, acquiring a first encoding feature for the target video frame under the first scale.

Alternatively, a manner of implementing the above step S121 (acquiring the first encoding feature for the target video frame under the first scale based on the intrinsic feature, and the encoding feature and the decoding feature under the first scale included in the first hidden variable set) may include the following step 1211 to step 1214:

step 1211, processing the intrinsic feature through the residual block, to acquire a first feature.

Assume that the intrinsic feature is Φₜ, the processing by the residual block for the feature is φ_{θ}( . . . ), the first feature is T₁, then:

T₁=φ_{θ}(Φₜ)

step 1212, processing the encoding feature under the first scale included in the first hidden variable set through the convolutional layer, to acquire a second feature.

Assume that the encoding feature under the first scale included in the first hidden variable set is fₜ₋₁^{e1}, the processing by the convolutional layer for the feature is Conv( . . . ), the second feature is T₂, then:

$${T}_{2} = Conv ( {f}_{t - 1}^{e 1} )$$

step 1213, processing the decoding feature under the first scale included in the first hidden variable set through the convolutional layer, to acquire a third feature.

Assume that the decoding feature under the first scale included in the first hidden variable set is fₜ₋₁^{d1}, the processing by the convolutional layer for the feature is Conv( . . . ), the third feature is T₃, then:

$${T}_{3} = Conv ( {f}_{t - 1}^{d 1} )$$

step 1214, performing the additive fusion on the first feature, the second feature and the third feature, to acquire the first encoding feature.

Assume that the first encoding feature is fₜ^{e1}, then:

$${f}_{t}^{e 1} = {T}_{1} + {T}_{2} + {T}_{3} = {φ}_{θ} ( {Φ}_{t} ) + Conv ( {f}_{t - 1}^{e 1} ) + Conv ( {f}_{t - 1}^{d 1} )$$

step 122, based on the first encoding feature, and the encoding feature and the decoding feature under the second scale included in the first hidden variable set, acquiring a second encoding feature for the target video frame under the second scale.

Alternatively, the step 122 (based on the first encoding feature, and the encoding feature and the decoding feature under the second scale included in the first hidden variable set, acquiring the second encoding feature for the target video frame under the second scale) may include the following step 1221 to 1225:

step 1221, downsampling the first encoding feature, to acquire a first downsampled feature.

Alternatively, the downsampling rate for downsampling the first encoding feature is 2. Namely, the first encoding feature is downsampled to a half of an original feature size.

step 1222, processing the first downsampled feature through the residual block, to acquire a fourth feature.

Assume that the downsampling rate is 2, the first encoding feature is fₜ^{e1}, the processing by the residual block for the feature is φ_{θ}( . . . ), and the fourth feature is T₄, then:

$${T}_{4} = {φ}_{θ} ( {( {f}_{t}^{e 1} )}^{↓ 2} )$$

step 1223, processing the encoding feature under the second scale included in the first hidden variable set through the convolutional layer, to acquire a fifth feature.

Assume that the encoding feature under the second scale included in the first hidden variable set is fₜ₋₁^{e2}, the processing by the convolutional layer for the feature is Conv( . . . ), the fifth feature is T₅, then:

$${T}_{5} = Conv ( {f}_{t - 1}^{e 2} )$$

step 1224, processing the decoding feature under the second scale included in the first hidden variable set through the convolutional layer, to acquire a sixth feature.

Assume that the decoding feature under the second scale included in the first hidden variable set is fₜ₋₁^{d2}, the processing by the convolutional layer for the feature is Conv( . . . ), the third feature is T₆, then:

$${T}_{6} = Conv ( {f}_{t - 1}^{d 2} )$$

step 1225, performing the additive fusion on the fourth feature, the fifth feature and the sixth feature, to acquire the second encoding feature.

Assume that the second encoding feature is fₜ^{e2}, then:

$${f}_{t}^{e 2} = {T}_{4} + {T}_{5} + {T}_{6} = {φ}_{θ} ( {( {f}_{t}^{e 1} )}^{↓ 2} ) + Conv ( {f}_{t - 1}^{e 2} ) + Conv ( {f}_{t - 1}^{d 2} )$$

step 123, based on the second encoding feature, and the encoding feature and the decoding feature under the third scale included in the first hidden variable set, acquiring a third encoding feature for the target video frame under the third scale.

Alternatively, the step 123 (based on the second encoding feature, and the encoding feature and the decoding feature under the third scale included in the first hidden variable set, acquiring a third encoding feature for the target video frame under the third scale) may include the following step 1231 to 1235:

step 1231, downsampling the second encoding feature, to acquire a second downsampled feature.

Alternatively, the downsampling rate for downsampling the second encoding feature is 2. Namely, the second encoding feature is downsampled to a half of an original feature size (a quarter of the intrinsic feature).

step 1232, processing the second downsampled feature through the residual block, to acquire a seventh feature.

Assume that the downsampling rate is 2, the second encoding feature is fₜ^{e2}, the processing by the residual block for the feature is φ_{θ}( . . . ), and the seventh feature is T₇, then:

$${T}_{7} = {φ}_{θ} ( {( {f}_{t}^{e 2} )}^{↓ 2} )$$

step 1233, processing the encoding feature under the third scale included in the first hidden variable set through the convolutional layer, to acquire an eighth feature.

Assume that the encoding feature under the third scale included in the first hidden variable set is fₜ₋₁^{e3}, the processing by the convolutional layer for the feature is Conv( . . . ), the eighth feature is T₈, then:

$${T}_{8} = Conv ( {f}_{t - 1}^{e 3} )$$

step 1234, processing the decoding feature under the third scale included in the first hidden variable set through the convolutional layer, to acquire a ninth feature.

Assume that the decoding feature under the third scale included in the first hidden variable set is fₜ₋₁^{d3}, the processing by the convolutional layer for the feature is Conv( . . . ), the ninth feature is T₉, then:

$${T}_{9} = C o n v ( {f}_{t - 1}^{d 3} )$$

step 1235, performing the additive fusion on the seventh feature, the eighth feature and the ninth feature, to acquire the third encoding feature.

Assume that the third encoding feature is fₜ^{e3}, then:

$${f}_{t}^{e 3} = {T}_{7} + {T}_{8} + {T}_{9} = {φ}_{θ} ( {( {f}_{t}^{e 2} )}^{↓ 2} ) + C o n v ( {f}_{t - 1}^{e 3} ) + C o n v ( {f}_{t - 1}^{d 3} )$$

step 124, based on the third encoding feature, acquiring a third decoding feature of the target video frame under the third scale.

Alternatively, a manner of implementing the step 124 (based on the third encoding feature, acquiring a third decoding feature of the target video frame under the third scale) is as follows:

processing the third encoding feature through the residual block, to acquire the third decoding feature.

Assume that the third encoding feature is fₜ^{e3}, the third decoding feature is fₜ^{d3}, the processing by the residual block for the feature is φ_{θ}( . . . ), then:

$${f}_{t}^{d 3} = {φ}_{θ} ( {f}_{t}^{e 3} )$$

step 125, based on the third decoding feature, and the encoding feature under the second scale included in the first hidden variable set, acquiring a second decoding feature for the target video frame under the second scale.

Alternatively, the step 125 (based on the third decoding feature, and the encoding feature under the second scale included in the first hidden variable set, acquiring a second decoding feature for the target video frame under the second scale) may include the following step 1251 to 1254:

step 1251, upsampling the third decoding feature, to acquire a first upsampled feature.

It should be noted that, the upsampling rate for upsampling the third decoding feature needs to be the same as the downsampling rate for the second decoding feature in the previous step. Exemplarily, the upsampling rate for upsampling the third decoding feature can be 2.

step 1252, processing the second encoding feature through the residual block, to acquire a tenth feature.

Assume that the second encoding feature is fₜ^{e2}, the tenth feature is T₁₀, and the processing by the residual block for the feature is φ_{θ}( . . . ), then:

$${T}_{10} = {φ}_{θ} ( {f}_{t}^{e 2} )$$

step 1253, performing the additive fusion on the first upsampled feature and the tenth feature, to acquire an eleventh feature.

Assume that the first upsampled feature is (fₜ^{d3})^{↑2}, and the eleventh feature is T₁₁, then:

$${T}_{11} = {( {f}_{t}^{d 3} )}^{↑ 2} + {T}_{10} = {( {f}_{t}^{d 3} )}^{↑ 2} + {φ}_{θ} ( {f}_{t}^{e 2} )$$

step 1254, processing the eleventh feature through the residual block, to acquire the second decoding feature.

Assume that the second decoding feature is fₜ^{d2}, and the processing by the residual block for the feature is φ_{θ}( . . . ), then:

$${f}_{t}^{d 2} = {φ}_{θ} ( {T}_{11} ) = {φ}_{θ} [ {( {f}_{t}^{d 3} )}^{↑ 2} + {φ}_{θ} ( {f}_{t}^{e 2} ) ]$$

step 126, based on the second decoding feature and the encoding feature under the first scale included in the first hidden variable set, acquiring the first decoding feature of the target video frame under the first scale.

Alternatively, the step 126 (based on the second decoding feature and the encoding feature under the first scale included in the first hidden variable set, acquiring the first decoding feature of the target video frame under the first scale) may include the following step 1261 to 1264:

step 1261, upsampling the second decoding feature, to acquire a second upsampled feature.

It should be noted that, the upsampling rate for upsampling the second decoding feature needs to be the same as the downsampling rate for the first decoding feature in the previous step. Exemplarily, the upsampling rate for upsampling the second decoding feature can be 2.

step 1262, processing the first encoding feature through the residual block, to acquire a twelfth feature.

Assume that the first encoding feature is fₜ^{e1}, the twelfth feature is T₁₂, and the processing by the residual block for the feature is φ_{θ}( . . . ), then:

$${T}_{12} = {φ}_{θ} ( {f}_{t}^{e 1} )$$

step 1263, performing the additive fusion on the second upsampled feature and the twelfth feature, to acquire a thirteenth feature.

Assume that the second upsampled feature is (fₜ^{d2})^{↑2}, and the twelfth feature is T₁₂, then:

$${T}_{13} = {( {f}_{t}^{d 2} )}^{↑ 2} + {T}_{12} = {( {f}_{t}^{d 2} )}^{↑ 2} + {φ}_{θ} ( {f}_{t}^{e 1} )$$

step 1264, processing the thirteenth feature through the residual block, to acquire the first decoding feature.

Assume that the first decoding feature is fₜ^{d1}, and the processing by the residual block for the feature is φ_{θ}( . . . ), then:

$${f}_{t}^{d 1} = {φ}_{θ} ( {T}_{13} ) = {φ}_{θ} [ {( {f}_{t}^{d 2} )}^{↑ 2} + {φ}_{θ} ( {f}_{t}^{e 1} ) ]$$

step 127, combing the first encoding feature, the second encoding feature, the third encoding feature, the first decoding feature, the second decoding feature and the third decoding feature to the forward hidden variable set of the target video frame.

Assume that a first hidden variable set (the forward hidden variable set of a previous video frame of the target video frame) is Fₜ₋₁, the forward hidden variable set of the target video frame is Fₜ, then:

$${F}_{t - 1} = \{ {f}_{t - 1}^{e 1} , {f}_{t - 1}^{e 2} , {f}_{t - 1}^{e 3} , {f}_{t - 1}^{d 1} , {f}_{t - 1}^{d 2} , {f}_{t - 1}^{d 3} \}$$

$${F}_{t} = \{ {f}_{t}^{e 1} , {f}_{t}^{e 2} , {f}_{t}^{e 3} , {f}_{t}^{d 1} , {f}_{t}^{d 2} , {f}_{t}^{d 3} \}$$

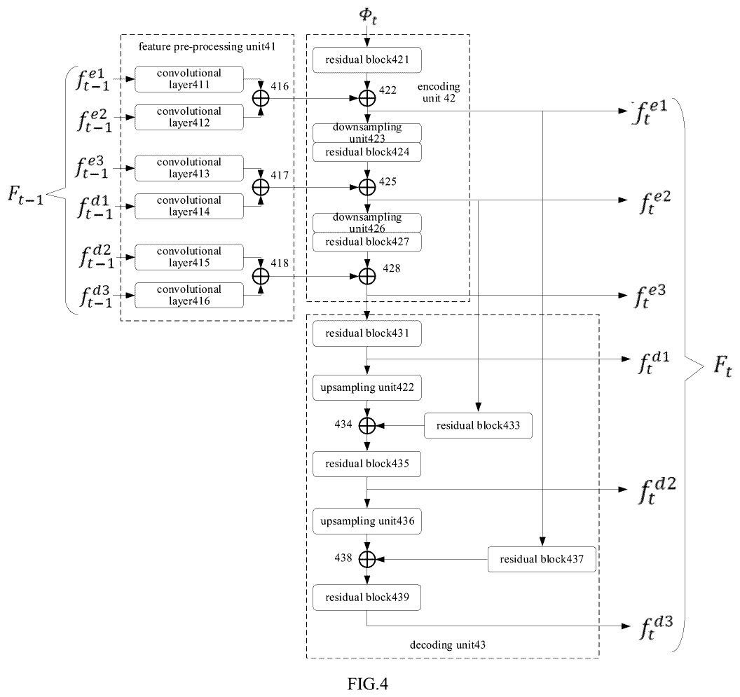

Further, referring to FIG. 4, a forward transfer module for acquiring the forward hidden variable set of the target video frame based on the intrinsic feature and the first hidden variable set may include a feature pre-processing unit 41, an encoding unit 42 and a decoding unit 43. Wherein, the feature pre-processing 41 may include a convolutional layer 411, a convolutional layer 412, a convolutional layer 413, a convolutional layer 414, a convolutional layer 415, a convolutional layer 416, an additive fusion unit 417, an additive fusion unit 418, and an additive fusion unit 419. The encoding unit 42 may include a residual block 421, the additive fusion unit 422, the downsampling unit 423, the residual block 424, the additive fusion unit 425, the downsampling unit 426, the residual block 427, and the additive fusion unit 428. The decoding unit 43 may include a residual block 431, the upsampling unit 432, the residual block 433, the additive fusion unit 434, the residual block 435, the upsampling unit 436, the residual block 437, the additive fusion unit 438, and the residual block 439.

S13, acquiring a backward hidden variable set of the target video frame based on the intrinsic feature and a second hidden variable set.

Wherein the second hidden variable set is the backward hidden variable set of a next video frame of the target video frame.

Namely, based on the intrinsic feature of the current frame and the backward hidden variable set of the next video frame, the backward hidden variable set of the current frame can be acquired.

As an alternative embodiment of the present disclosure, the backward hidden variable set may include an encoding feature and a decoding feature under a first scale, an encoding feature and a decoding feature under a second scale, and an encoding feature and a decoding feature under a third scale.

Namely, the backward hidden variable set may include features pairs (the encoding feature and the decoding feature) under three spatial scales.

Similarly, on the basis of the above embodiments, the backward hidden variable set in embodiments of the present disclosure may further include feature pairs under other number of spatial scales, which are not limited in embodiments of the present disclosure, as long as the forward hidden variable set has the same number of feature pairs as backward hidden variable set.

As an alternative embodiment of the present disclosure, on the basis that the backward hidden variable set may include an encoding feature and a decoding feature under a first scale, an encoding feature and a decoding feature under a second scale, and an encoding feature and a decoding feature under a third scale, the steps of implementing the above step S13 (acquiring a backward hidden variable set of the target video frame based on the intrinsic feature and a second hidden variable set) may include the following step 131 to step 137:

Step 131: based on the intrinsic feature, and the encoding feature and the decoding feature under the first scale included in the second hidden variable set, acquiring a fourth encoding feature for the target video frame under the first scale.

Alternatively, a manner of implementing the above step S131 (acquiring a fourth encoding feature for the target video frame under the first scale based on the intrinsic feature, and the encoding feature and the decoding feature under the first scale included in the second hidden variable set) may include the following step 1311 to step 1314:

step 1311, processing the intrinsic feature through the residual block, to acquire a first feature.

Assume that the intrinsic feature is Φₜ, the processing by the residual block for the feature is φ_{θ}( . . . ), the first feature is T₁, then:

T₁=φ_{θ}(Φₜ)

step 1312, processing the encoding feature under the first scale included in the second hidden variable set through the convolutional layer, to acquire a fourteenth feature.

Assume that the encoding feature under the first scale included in the second hidden variable set is bₜ₊₁^{e1}, the processing by the convolutional layer for the feature is Conv( . . . ), the fourteenth feature is T₁₄, then:

$${T}_{14} = C o n v ( {b}_{t + 1}^{e 1} )$$

step 1313, processing the decoding feature under the first scale included in the second hidden variable set through the convolutional layer, to acquire a fifteenth feature.

Assume that the decoding feature under the first scale included in the second hidden variable set is bₜ₊₁^{d1}, the processing by the convolutional layer for the feature is Conv( . . . ), the fifteenth feature is T₁₅, then:

$${T}_{15} = C o n v ( {b}_{t + 1}^{d 1} )$$

step 1314, performing the additive fusion on the first feature, the fourteenth feature and the fifteenth feature, to acquire the fourth encoding feature.

Assume that the fourth encoding feature is bₜ^{e1}, then:

$${b}_{t}^{e 1} = {T}_{1} + {T}_{14} + {T}_{15} = {φ}_{θ} ( {Φ}_{t} ) + C o n v ( {b}_{t + 1}^{e 1} ) + C o n v ( {b}_{t + 1}^{d 1} )$$

step 132, based on the fourth encoding feature, and the encoding feature and the decoding feature under the second scale included in the second hidden variable set, acquiring a fifth encoding feature for the target video frame under the second scale.

Alternatively, the step 132 (based on the fourth encoding feature, and the encoding feature and the decoding feature under the second scale included in the second hidden variable set, acquiring a fifth encoding feature for the target video frame under the second scale) may include the following step 1321 to 1325:

step 1321, downsampling the fourth encoding feature, to acquire a third downsampled feature.

Alternatively, the downsampling rate for downsampling the fourth encoding feature is 2. Namely, the fourth encoding feature is downsampled to a half of an original feature size.

step 1322, processing the third downsampled feature through the residual block, to acquire a sixteenth feature.

Assume that the downsampling rate is 2, the fourth encoding feature is bₜ^{e1}, the processing by the residual block for the feature is φ_{θ}( . . . ), and the sixteenth feature is T₁₆, then:

$${T}_{16} = {φ}_{θ} ( {( {b}_{t}^{e 1} )}^{↓ 2} )$$

step 1323, processing the encoding feature under the second scale included in the second hidden variable set through the convolutional layer, to acquire a seventeenth feature.

Assume that the encoding feature under the second scale included in the first hidden variable set is bₜ₊₁^{e2}, the processing by the convolutional layer for the feature is Conv( . . . ), the seventeenth feature is T₁₇, then:

$${T}_{17} = C o n v ( {b}_{t + 1}^{e 2} )$$

step 1324, processing the decoding feature under the second scale included in the second hidden variable set through the convolutional layer, to acquire an eighteenth feature.

Assume that the decoding feature under the second scale included in the second hidden variable set is bₜ₊₁^{d2}, the processing by the convolutional layer for the feature is Conv( . . . ), the eighteenth feature is T₁₈, then:

$${T}_{18} = Conv ( {b}_{t + 1}^{d 2} )$$

step 1325, performing the additive fusion on the sixteenth feature, the seventeenth feature and the eighteenth feature, to acquire the fifth encoding feature.

Assume that the fifth encoding feature is bₜ^{e2}, then:

$${b}_{t}^{e 2} = {T}_{16} + {T}_{17} + {T}_{18} = {φ}_{θ} ( {( {b}_{t}^{e 1} )}^{↓ 2} ) + Conv ( {b}_{t + 1}^{e 2} ) + Conv ( {b}_{t + 1}^{d 2} )$$

step 133, based on the fifth encoding feature, and the encoding feature and the decoding feature under the third scale included in the second hidden variable set, acquiring a sixth encoding feature for the target video frame under the third scale.

Alternatively, the step 133 (based on the fifth encoding feature, and the encoding feature and the decoding feature under the third scale included in the second hidden variable set, acquiring a sixth encoding feature for the target video frame under the third scale) may include the following step 1331 to 1335:

step 1331, downsampling the fifth encoding feature, to acquire a fourth downsampled feature.

Alternatively, the downsampling rate for downsampling the fifth encoding feature is 2. Namely, the fifth encoding feature is downsampled to a half of an original feature size (a quarter of the intrinsic feature).

step 1332, processing the fourth downsampled feature through the residual block, to acquire a nineteenth feature.

Assume that the downsampling rate is 2, the fifth encoding feature is bₜ^{e2}, the processing by the residual block for the feature is φ_{θ}( . . . ), and the nineteenth feature is T₁₉, then:

$${T}_{19} = {φ}_{θ} ( {( {b}_{t}^{e 2} )}^{↓ 2} )$$

step 1333, processing the encoding feature under the third scale included in the second hidden variable set through the convolutional layer, to acquire a twentieth feature.

Assume that the encoding feature under the third scale included in the second hidden variable set is bₜ₊₁^{e3}, the processing by the convolutional layer for the feature is Conv( . . . ), the twentieth feature is T₂₀, then:

$${T}_{20} = Conv ( {b}_{t + 1}^{e 3} )$$

step 1334, processing the decoding feature under the third scale included in the second hidden variable set through the convolutional layer, to acquire a twenty-first feature.

Assume that the decoding feature under the third scale included in the second hidden variable set is bₜ₊₁^{d3}, the processing by the convolutional layer for the feature is Conv( . . . ), the twenty-first feature is T₂₁, then:

$${T}_{21} = Conv ( {b}_{t + 1}^{d 3} )$$

step 1335, performing the additive fusion on the nineteenth feature, the twentieth feature and the twenty-first feature, to acquire the sixth encoding feature.

Assume that the sixth encoding feature is bₜ^{e3}, then:

$${b}_{t}^{e 3} = {T}_{19} + {T}_{20} + {T}_{21} = {φ}_{θ} ( {( {b}_{t}^{e 2} )}^{↓ 2} ) + Conv ( {b}_{t + 1}^{e 3} ) + Conv ( {b}_{t + 1}^{d 3} )$$

step 134, based on the sixth encoding feature, acquiring a sixth decoding feature of the target video frame under the third scale.

Alternatively, a manner of implementing the step 134 (based on the sixth encoding feature, acquiring a sixth decoding feature of the target video frame under the third scale) is as follows:

processing the sixth encoding feature through the residual block, to acquire the sixth decoding feature.

Assume that the third encoding feature is bₜ^{e3}, the third decoding feature is bₜ^{d3}, the processing by the residual block for the feature is φ_{θ}( . . . ), then:

$${b}_{t}^{d 3} = {φ}_{θ} ( {b}_{t}^{e 3} )$$

step 135, based on the sixth decoding feature, and the encoding feature under the second scale included in the second hidden variable set, acquiring a fifth decoding feature for the target video frame under the second scale.

Alternatively, the step 135 (based on the sixth decoding feature, and the encoding feature under the second scale included in the second hidden variable set, acquiring a fifth decoding feature for the target video frame under the second scale) may include the following step 1351 to 1354:

step 1351, upsampling the sixth decoding feature, to acquire a third upsampled feature.

It should be noted that, the upsampling rate for upsampling the sixth decoding feature needs to be the same as the downsampling rate for the fifth decoding feature in the previous step. Exemplarily, the upsampling rate for upsampling the sixth decoding feature can be 2.

step 1352, processing the fifth encoding feature through the residual block, to acquire a twenty-second feature.

Assume that the second encoding feature is bₜ^{e2}, the twenty-second feature is T₂₂, and the processing by the residual block for the feature is φ_{θ}( . . . ), then:

$${T}_{22} = {φ}_{θ} ( {b}_{t}^{e 2} )$$

step 1353, performing the additive fusion on the second upsampled feature and the twenty-second feature, to acquire a twenty-third feature.

Assume that the second upsampled feature is (bₜ^{d3})^{↑2}, and the twenty-third feature is T₂₃, then:

$${T}_{23} = {( {b}_{t}^{d 3} )}^{↑ 2} + {T}_{22} = {( {b}_{t}^{d 3} )}^{↑ 2} + {φ}_{θ} ( {b}_{t}^{e 2} )$$

step 1354, processing the twenty-third feature through the residual block, to acquire the fifth decoding feature.

Assume that the fifth decoding feature is bₜ^{d2}, and the processing by the residual block for the feature is φ_{θ}( . . . ), then:

$${b}_{t}^{d 2} = {φ}_{θ} ( {T}_{23} ) = {φ}_{θ} [ {( {b}_{t}^{d 3} )}^{↑ 2} + {φ}_{θ} ( {b}_{t}^{e 2} ) ]$$

step 136, based on the fifth decoding feature and the encoding feature under the first scale included in the second hidden variable set, acquiring the fourth decoding feature of the target video frame under the first scale.

Alternatively, the step 136 (based on the second decoding feature and the encoding feature under the first scale included in the first hidden variable set, acquiring the first decoding feature of the target video frame under the first scale) may include the following step 1361 to 1364:

step 1361, upsampling the fifth decoding feature, to acquire a fourth upsampled feature.

It should be noted that, the upsampling rate for upsampling the fifth decoding feature needs to be the same as the downsampling rate for the fourth decoding feature in the previous step. Exemplarily, the upsampling rate for upsampling the fifth decoding feature can be 2.

step 1362, processing the fourth encoding feature through the residual block, to acquire a twenty-fourth feature.

Assume that the fourth encoding feature is bₜ^{e1}, the twenty-fourth feature is T₂₄, and the processing by the residual block for the feature is φ_{θ}( . . . ), then:

$${T}_{24} = {φ}_{θ} ( {b}_{t}^{e 1} )$$

step 1363, performing the additive fusion on the fourth upsampled feature and the twenty-fourth feature, to acquire a twenty-fifth feature.

Assume that the fourth upsampled feature is (bᵣ^{d2})^{↑2}, and the twenty-fifth feature is T₂₅, then:

$${T}_{25} = {( {b}_{t}^{d 2} )}^{↑ 2} + {T}_{24} = {( {b}_{t}^{d 2} )}^{↑ 2} + {φ}_{θ} ( {b}_{t}^{e 1} )$$

step 1364, processing the twenty-fifth feature through the residual block, to acquire the fourth decoding feature.

Assume that the fourth decoding feature is bₜ^{d1}, and the processing by the residual block for the feature is φ_{θ}( . . . ), then:

$${b}_{t}^{d 1} = {φ}_{θ} ( {T}_{25} ) = {φ}_{θ} [ {( {b}_{t}^{d 2} )}^{↑ 2} + {ϕ}_{θ} ( {b}_{t}^{e 1} ) ]$$

step 137, combing the fourth encoding feature, the fifth encoding feature, the sixth encoding feature, the fourth decoding feature, the fifth decoding feature and the sixth decoding feature to the backward hidden variable set of the target video frame.

Assume that a second hidden variable set (the backward hidden variable set of a next video frame of the target video frame) is Bₜ₊₁, the backward hidden variable set of the target video frame is Bₜ, then:

$${B}_{t + 1} = \{ {b}_{t + 1}^{e 1} , {b}_{t + 1}^{e 2} , {b}_{t + 1}^{e 3} , {b}_{t + 1}^{d 1} , {b}_{t + 1}^{d 2} , {b}_{t + 1}^{d 3} \}$$

$${B}_{t} = \{ {b}_{t}^{e 1} , {b}_{t}^{e 2} , {b}_{t}^{e 3} , {b}_{t}^{d 1} , {b}_{t}^{d 2} , {b}_{t}^{d 3} \}$$

Further, referring to FIG. 5, a backward transfer module for acquiring the backward hidden variable set of the target video frame based on the intrinsic feature and the second hidden variable set may include a feature pre-processing unit 51, an encoding unit 52 and a decoding unit 53. Wherein, the feature pre-processing 51 may include a convolutional layer 511, a convolutional layer 512, a convolutional layer 513, a convolutional layer 514, a convolutional layer 515, a convolutional layer 516, an additive fusion unit 517, an additive fusion unit 518, and an additive fusion unit 519. The encoding unit 52 may include a residual block 521, the additive fusion unit 522, the downsampling unit 523, the residual block 524, the additive fusion unit 525, the downsampling unit 526, the residual block 527, and the additive fusion unit 528. The decoding unit 53 may include a residual block 531, the upsampling unit 532, the residual block 533, the additive fusion unit 534, the residual block 535, the upsampling unit 536, the residual block 537, the additive fusion unit 538, and the residual block 539.

S14, acquiring an enhanced feature of the target video frame based on the intrinsic feature, the forward hidden variable set of the target video frame, and the backward hidden variable set of the target video frame.

As an alternative embodiment of the present disclosure, the above step S14 (acquiring an enhanced feature of the target video frame based on the intrinsic feature, the forward hidden variable set of the target video frame, and the backward hidden variable set of the target video frame) may include the following step 141 to step 144:

Step 141: fusing the intrinsic feature, the first encoding feature, the fourth encoding feature, the first decoding feature and the fourth decoding feature, to acquire a twenty-sixth feature.

Alternatively, a manner of implementing the above step S141 (fusing the intrinsic feature, the first encoding feature, the fourth encoding feature, the first decoding feature and the fourth decoding feature, to acquire a twenty-sixth feature) may include the following step 1411 to step 1416:

step 1411, processing the intrinsic feature through the residual block, to acquire a first feature.

Assume that the intrinsic feature is Φₜ, the processing by the residual block for the feature is φ_{θ}( . . . ), the first feature is T₁, then:

T₁=φ_{θ}(Φₜ)

step 1412, performing the additive fusion on the first encoding feature and the fourth encoding feature, to acquire a first fusion feature.

Assume that the first fusion feature is Tₜ^{e1}, the first encoding feature is fₜ^{e1}, and the fourth encoding feature is bₜ^{e1}, then:

$${T}_{t}^{e 1} = {f}_{t}^{e 1} + {b}_{t}^{e 1}$$

step 1413, processing the first fusion feature through the convolutional layer, to acquire a first convolutional feature.

Assume that the processing by the convolutional layer for the feature is Conv( . . . ), the first convolutional feature is Cₜ^{e1}, then:

$${C}_{t}^{e 1} = C o n v ( {T}_{t}^{e 1} ) = C o n v ( {f}_{t}^{e 1} + {b}_{t}^{e 1} )$$

step 1414, performing the additive fusion on the first decoding feature and the fourth decoding feature, to acquire a second fusion feature.

Assume that the second fusion feature is Tₜ^{d1}, the first decoding feature is fₜ^{d1}, and the fourth decoding feature is bₜ^{d1}, then:

$${T}_{t}^{d 1} = {f}_{t}^{d 1} + {b}_{t}^{d 1}$$

step 1415, processing the second fusion feature through the convolutional layer, to acquire a second convolutional feature.

Assume that the processing by the convolutional layer for the feature is Conv( . . . ), the second convolutional feature is Cₜ^{d1}, then:

$${C}_{t}^{d 1} = C o nv ( {T}_{t}^{d 1} ) = C o n v ( {f}_{t}^{d 1} + {b}_{t}^{d 1} )$$

step 1416, performing the additive fusion on the first feature, the first convolutional feature, and the second convolutional feature, to acquire the twenty-sixth feature.

Assume that the twenty-sixth feature is T₂₆, then:

$${T}_{26} = {φ}_{θ} ( {ϕ}_{t} ) + C o n v ( {f}_{t}^{e 1} + {b}_{t}^{e 1} ) + C o n v ( {f}_{t}^{d 1} + {b}_{t}^{d 1} )$$

step 142, fusing the twenty-sixth feature, the second encoding feature, the fifth encoding feature, the second decoding feature and the fifth decoding feature, to acquire a twenty-seventh feature.

Alternatively, a manner of implementing the above step S142 (fusing the twenty-sixth feature, the second encoding feature, the fifth encoding feature, the second decoding feature and the fifth decoding feature, to acquire a twenty-seventh feature) may include the following step 1421 to step 1428:

step 1421, processing the twenty-sixth feature through the residual block, to acquire a first residual feature.

Assume that the twenty-sixth feature is T₂₆, the processing by the residual block for the feature is φ_{θ}( . . . ), the first residual feature is R₁, then:

R₁=φ_{θ}(T₂₆)

step 1422, performing the additive fusion on the second encoding feature and the fifth encoding feature, to acquire a third fusion feature.

Assume that the third fusion feature is Tₜ^{e2}, the second encoding feature is fₜ^{e2}, and the fifth encoding feature is bₜ^{e2}, then:

$${T}_{t}^{e 2} = {f}_{t}^{e 2} + {b}_{t}^{e 2}$$

step 1423, processing the third fusion feature through the convolutional layer, to acquire a third convolutional feature.

Assume that the processing by the convolutional layer for the feature is Conv( . . . ), the third convolutional feature is Cₜ^{e2}, then:

$${C}_{t}^{e 2} = C o n v ( {T}_{t}^{e 2} ) = C o n v ( {f}_{t}^{e 2} + {b}_{t}^{e 2} )$$

step 1424, upsampling the third convolutional feature, to acquire a fifth upsampled feature.

Where, the upsampling rate for upsampling the third convolutional feature is equal to the downsampling rate for downsampling the second decoding feature.

step 1425, performing the additive fusion on the second decoding feature and the fifth decoding feature, to acquire a fourth fusion feature.

Assume that the fourth fusion feature is Tₜ^{d2}, the second decoding feature is fₜ^{d2}, and the fifth decoding feature is bₜ^{d2}, then:

$${T}_{t}^{d 2} = {f}_{t}^{d 2} + {b}_{t}^{d 2}$$

step 1426, processing the fourth fusion feature through the convolutional layer, to acquire a fourth convolutional feature.

Assume that the processing by the convolutional layer for the feature is Conv( . . . ), the fourth convolutional feature is Cₜ^{d2}, then:

$${C}_{t}^{d 2} = Conv ( {T}_{t}^{d 2} ) = Conv ( {f}_{t}^{d 2} + {b}_{t}^{d 2} )$$

step 1427, upsampling the fourth convolutional feature, to acquire a sixth upsampled feature.

Where, the upsampling rate for upsampling the fourth convolutional feature is equal to the downsampling rate for downsampling the second decoding feature.

step 1428, performing the additive fusion on the first residual feature, the fifth upsampled feature, and the sixth unsampled feature, to acquire the twenty-seventh feature.

Assume that the twenty-seventh feature is T₂₇, then:

$${T}_{27} = {φ}_{θ} ( {T}_{26} ) + {[ C o n v ( {f}_{t}^{e 2} + {b}_{t}^{e 2} ) ]}^{↑ 2} + {[ C o n v ( {f}_{t}^{d 2} + {b}_{t}^{d 2} ) ]}^{↑ 2}$$

step 143, fusing the twenty-seventh feature, the third encoding feature, the sixth encoding feature, the third decoding feature and the sixth decoding feature, to acquire a twenty-eighth feature.

Alternatively, the step 143 (fusing the twenty-seventh feature, the third encoding feature, the sixth encoding feature, the third decoding feature and the sixth decoding feature, to acquire a twenty-eighth feature) may include the following step 1431 to 1436:

step 1431, processing the twenty-seventh feature through the residual block, to acquire a second residual feature.

Assume that the twenty-seventh feature is T₂₇, the processing by the residual block for the feature is φ_{θ}( . . . ), the second residual feature is R₂, then:

R₂=φ_{θ}(T₂₇)

step 1432, performing the additive fusion on the third encoding feature and the sixth encoding feature, to acquire a fifth fusion feature.

Assume that the fifth fusion feature is Tₜ^{e3}, the third encoding feature is fₜ^{e3}, and bₜ^{e3}, then:

$${T}_{t}^{e 3} = {f}_{t}^{e 3} + {b}_{t}^{e 3}$$

step 1433, processing the fifth fusion feature through the convolutional layer, to acquire a fifth convolutional feature.

Assume that the processing by the convolutional layer for the feature is Conv( . . . ), the fifth convolutional feature is Cₜ^{e3}, then:

$${C}_{t}^{e 3} = C o n v ( {T}_{t}^{e 3} ) = C o n v ( {f}_{t}^{e 3} + {b}_{t}^{e 3} )$$

step 1434, upsampling the fifth convolutional feature, to acquire a seventh upsampled feature.

Where, the upsampling rate for upsampling the sixth convolutional feature is a product of the downsampling rate for downsampling the first decoding feature and the downsampling rate for downsampling the second decoding feature.

step 1435, performing the additive fusion on the third decoding feature and the sixth decoding feature, to acquire a sixth fusion feature.

Assume that the sixth fusion feature is Tₜ^{d3}, the third decoding feature is fₜ^{d3}, and bₜ^{d3}, then:

$${T}_{t}^{d 3} = {f}_{t}^{d 3} + {b}_{t}^{d 3}$$

step 1436, processing the sixth fusion feature through the convolutional layer, to acquire a sixth convolutional feature.

Assume that the processing by the convolutional layer for the feature is Conv( . . . ), the sixth convolutional feature is Cₜ^{d3}, then:

$${C}_{t}^{d 3} = C o nv ( {T}_{t}^{d 3} ) = C o n v ( {f}_{t}^{d 3} + {b}_{t}^{d 3} )$$

step 1437, upsampling the sixth convolutional feature, to acquire an eighth upsampled feature.

Where, the upsampling rate for upsampling the sixth convolutional feature is a product of the downsampling rate for downsampling the first decoding feature and the downsampling rate for downsampling the second decoding feature.

step 1438, performing the additive fusion on the second residual feature, the seventh upsampled feature, and the eighth unsampled feature, to acquire the twenty-eighth feature.

Assume that the twenty-eighth feature is T₂₈, then:

$${T}_{28} = {φ}_{θ} ( {T}_{27} ) + {[ C o n v ( {f}_{t}^{e 3} + {b}_{t}^{e 3} ) ]}^{↑ 4} + {[ C o n v ( {f}_{t}^{d 3} + {b}_{t}^{d 3} ) ]}^{↑ 4}$$

step 144, processing the twenty-eighth feature through the convolutional layer, to acquire an enhanced feature of the target video frame.

Assume that that the processing by the convolutional layer for the feature is Conv( . . . ), the enhanced feature is Iₜ′, then:

Iₜ′=Conv(T₂₈)

Alternatively, the convolution kernel of the convolutional layer for processing the twenty-eighth feature can be 5*5.

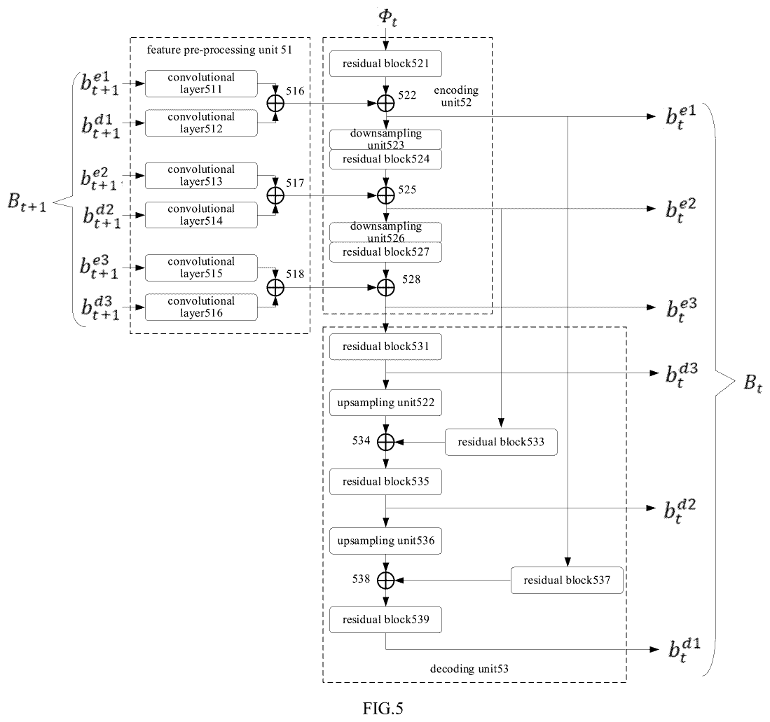

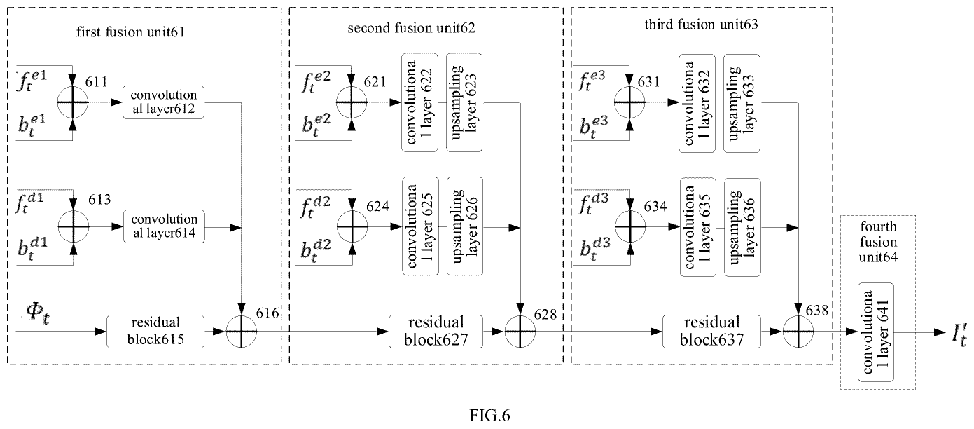

Exemplarily, as shown in FIG. 6, a feature enhancement unit configured to acquire an enhanced feature of the target video frame based on the intrinsic feature, the forward hidden variable set of the target video frame, and the backward hidden variable set of the target video frame may include: a first fusion unit 61, a second fusion unit 62, a third fusion unit 63, and a fourth fusion unit 64. Wherein, the first fusion unit 61 may include: an additive fusion unit 611, a convolutional layer 612, an additive fusion unit 613, a convolutional layer 614, a residual block 615, and an additive fusion unit 616. The second fusion unit 62 may include: an additive fusion unit 621, a convolutional layer 622, an upsampling unit 623, an additive fusion unit 624, a convolutional layer 625, an upsampling unit 626, the residual block 627, and the additive fusion unit 628. The third fusion unit 63 may include: an additive fusion unit 631, a convolutional layer 632, an upsampling unit 633, an additive fusion unit 634, a convolutional layer 635, an upsampling unit 636, a residual error block 637, and an additive fusion unit 638. The fourth fusion unit 64 may include a convolutional layer 641.

S15, performing additive fusion on the enhanced feature of the target video frame and the target video frame, so as to acquire a deblurred video frame from the target video frame.

Assume that the deblurred video frame from the target video frame is Oₜ, the enhanced feature of the target video frame is Iₜ′, the target video frame is Iₜ, then:

$${O}_{t} = {I}_{t} + {I}_{t}^{′}$$

Exemplarily, as shown in FIG. 7, acquisition unit, configured to perform additive fusion on the enhanced feature of the target video frame and the target video frame, so as to acquire a deblurred video frame from the target video frame, may include: an additive fusion unit 71. The input of the additive fusion unit 71 can be the enhanced feature of the target video frame is Iₜ′, the target video frame is Iₜ, and the output of the additive fusion unit 71 can be the deblurred video frame Oₜ from the target video frame.

The blurry video repair method provided by embodiments of the present disclosure, upon repairing the target video frame in the video, firstly performing feature extraction on a target video frame of a video to be repaired, so as to acquire an intrinsic feature of the target video frame; then acquiring a forward hidden variable set of the target video frame based on the intrinsic feature and a first hidden variable set, and acquiring a backward hidden variable set of the target video frame based on the intrinsic feature and a second hidden variable set, then acquiring an enhanced feature of the target video frame based on the intrinsic feature, the forward hidden variable set of the target video frame, and the backward hidden variable set of the target video frame; and finally performing additive fusion on the enhanced feature of the target video frame and the target video frame, so as to acquire a deblurred video frame from the target video frame. Compared with the existing technology which eliminates the displacement between adjacent frames by an explicit motion compensation module, the embodiments of the present disclosure utilize a forward-transferred forward hidden variable set and a backward-transferred backward hidden variable set to perform additive fusion on hidden variables of adjacent video frame, so as to avoid the video deblurring network to obtain wrong information from the adjacent video frames, improving the efficiency of utilizing information about the adjacent video frames, so that the embodiments of the present disclosure can improve the deblurring effect of video deblurring.

On basis of the same inventive concept, as implementation of the method as described above, the present disclosure further provides a blurry video repair apparatus, the apparatus embodiment corresponds to the method embodiment, and for easy of reading, the apparatus embodiment does not repeat the details of the method embodiment as described above, but it is clear that the blurry video repair apparatus in this embodiment can correspondingly realize all the contents in the above method embodiments.

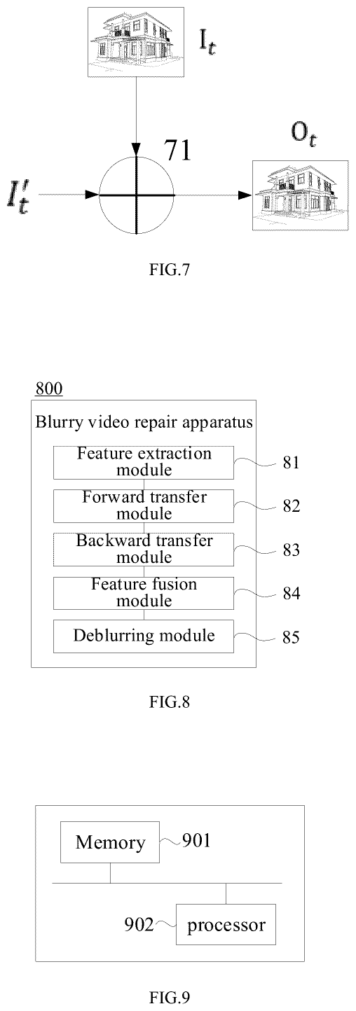

The present disclosure provides a blurry video repair apparatus, FIG. 8 is the structural schematic diagram of the blurry video repair apparatus, as shown in FIG. 8, the blurry video repair apparatus 800 may include:
a feature extraction module 81 configured to perform feature extraction on a target video frame of a video to be repaired, so as to acquire an intrinsic feature of the target video frame;
a forward transfer module 82 configured to acquire a forward hidden variable set of the target video frame based on the intrinsic feature and a first hidden variable set, wherein the first hidden variable set is the forward hidden variable set of a previous video frame of the target video frame;
a backward transfer module 83 configured to acquire a backward hidden variable set of the target video frame based on the intrinsic feature and a second hidden variable set, wherein the second hidden variable set is the backward hidden variable set of a next video frame of the target video frame;
a feature fusion module 84 configured to acquire an enhanced feature of the target video frame based on the intrinsic feature, the forward hidden variable set of the target video frame, and the backward hidden variable set of the target video frame; and
a deblurring module 85 configured to perform additive fusion on the enhanced feature of the target video frame and the target video frame, so as to acquire a deblurred video frame from the target video frame.

As an alternative embodiment of the present disclosure, the feature extraction module 81 is specifically configured to:
process the target video frame through a convolutional layer, to acquire a convolutional feature;
process the convolutional feature through a residual block, to acquire the intrinsic feature of the target video frame.

As an alternative embodiment of the present disclosure, the forward transfer module 82 is specifically configured to:
based on the intrinsic feature, and the encoding feature and the decoding feature under the first scale included in the first hidden variable set, acquire a first encoding feature for the target video frame under the first scale;
based on the first encoding feature, and the encoding feature and the decoding feature under the second scale included in the first hidden variable set, acquire a second encoding feature for the target video frame under the second scale;
based on the second encoding feature, and the encoding feature and the decoding feature under the third scale included in the first hidden variable set, acquire a third encoding feature for the target video frame under the third scale;
based on the third encoding feature, acquire a third decoding feature of the target video frame under the third scale;
based on the third decoding feature, and the encoding feature under the second scale included in the first hidden variable set, acquire a second decoding feature for the target video frame under the second scale.
based on the second decoding feature and the encoding feature under the first scale included in the first hidden variable set, acquire the first decoding feature of the target video frame under the first scale.
combine the first encoding feature, the second encoding feature, the third encoding feature, the first decoding feature, the second decoding feature and the third decoding feature to the forward hidden variable set of the target video frame.

As an alternative embodiment of the present disclosure, the forward transfer module 82 is specifically configured to:
process the intrinsic feature through the residual block, to acquire a first feature;
process the encoding feature under the first scale included in the first hidden variable set through the convolutional layer, to acquire a second feature;
process the decoding feature under the first scale included in the first hidden variable set through the convolutional layer, to acquire a third feature;
perform additive fusion on the first feature, the second feature and the third feature, to acquire the first encoding feature.

As an alternative embodiment of the present disclosure, the forward transfer module 82 is specifically configured to:
downsample the first encoding feature, to acquire a first downsampled feature;
process the first downsampled feature through the residual block, to acquire a fourth feature;
process the encoding feature under the second scale included in the first hidden variable set through the convolutional layer, to acquire a fifth feature;
process the decoding feature under the second scale included in the first hidden variable set through the convolutional layer, to acquire a sixth feature;
perform additive fusion on the fourth feature, the fifth feature and the sixth feature, to acquire the second encoding feature.

As an alternative embodiment of the present disclosure, the forward transfer module 82 is specifically configured to:
downsample the second encoding feature, to acquire a second downsampled feature.
process the second downsampled feature through the residual block, to acquire a seventh feature.
processing the encoding feature under the third scale included in the first hidden variable set through the convolutional layer, to acquire an eighth feature.
process the decoding feature under the third scale included in the first hidden variable set through the convolutional layer, to acquire a ninth feature.
performing additive fusion on the seventh feature, the eighth feature and the ninth feature, to acquire the third encoding feature.

As an alternative embodiment of the present disclosure, the forward transfer module 82 is specifically configured to:
processing the third encoding feature through the residual block, to acquire the third decoding feature.

As an alternative embodiment of the present disclosure, the forward transfer module 82 is specifically configured to:
upsample the third decoding feature, to acquire a first upsampled feature.
process the second encoding feature through the residual block, to acquire a tenth feature.
perform additive fusion on the first upsampled feature and the tenth feature, to acquire an eleventh feature.
process the eleventh feature through the residual block, to acquire the second decoding feature.

As an alternative embodiment of the present disclosure, the forward transfer module 82 is specifically configured to:
upsample the second decoding feature, to acquire a second upsampled feature;
process the first encoding feature through the residual block, to acquire a twelfth feature;
performing additive fusion on the second upsampled feature and the twelfth feature, to acquire a thirteenth feature;
process the thirteenth feature through the residual block, to acquire the first decoding feature.

As an alternative embodiment of the present disclosure, the backward transfer module 83 is specifically configured to:
based on the intrinsic feature, and the encoding feature and the decoding feature under the first scale included in the second hidden variable set, acquire a fourth encoding feature for the target video frame under the first scale;
based on the fourth encoding feature, and the encoding feature and the decoding feature under the second scale included in the second hidden variable set, acquire a fifth encoding feature for the target video frame under the second scale;
based on the fifth encoding feature, and the encoding feature and the decoding feature under the third scale included in the second hidden variable set, acquire a sixth encoding feature for the target video frame under the third scale;
based on the sixth encoding feature, acquire a sixth decoding feature of the target video frame under the third scale;
based on the sixth decoding feature, and the encoding feature under the second scale included in the second hidden variable set, acquire a fifth decoding feature for the target video frame under the second scale;
based on the fifth decoding feature and the encoding feature under the first scale included in the second hidden variable set, acquire the fourth decoding feature of the target video frame under the first scale;
combing the fourth encoding feature, the fifth encoding feature, the sixth encoding feature, the fourth decoding feature, the fifth decoding feature and the sixth decoding feature to the backward hidden variable set of the target video frame.

As an alternative embodiment of the present disclosure, the backward transfer module 83 is specifically configured to:
process the intrinsic feature through the residual block, to acquire a first feature;
process the encoding feature under the first scale included in the second hidden variable set through the convolutional layer, to acquire a fourteenth feature;
process the decoding feature under the first scale included in the second hidden variable set through the convolutional layer, to acquire a fifteenth feature;
perform additive fusion on the first feature, the fourteenth feature and the fifteenth feature, to acquire the fourth encoding feature.

As an alternative embodiment of the present disclosure, the backward transfer module 83 is specifically configured to:
downsample the fourth encoding feature, to acquire a third downsampled feature;
process the third downsampled feature through the residual block, to acquire a sixteenth feature;
processing the encoding feature under the second scale included in the second hidden variable set through the convolutional layer, to acquire a seventeenth feature;
processing the decoding feature under the second scale included in the second hidden variable set through the convolutional layer, to acquire an eighteenth feature;
performing additive fusion on the sixteenth feature, the seventeenth feature and the eighteenth feature, to acquire the fifth encoding feature.

As an alternative embodiment of the present disclosure, the backward transfer module 83 is specifically configured to:
downsample the fifth encoding feature, to acquire a fourth downsampled feature;
process the fourth downsampled feature through the residual block, to acquire a nineteenth feature;
process the encoding feature under the third scale included in the second hidden variable set through the convolutional layer, to acquire a twentieth feature;
process the decoding feature under the third scale included in the second hidden variable set through the convolutional layer, to acquire a twenty-first feature;
perform additive fusion on the nineteenth feature, the twentieth feature and the twenty-first feature, to acquire the sixth encoding feature.

As an alternative embodiment of the present disclosure, the backward transfer module 83 is specifically configured to:
process the sixth encoding feature through the residual block, to acquire the sixth decoding feature.

As an alternative embodiment of the present disclosure, the backward transfer module 83 is specifically configured to:
upsample the sixth decoding feature, to acquire a third upsampled feature;
process the fifth encoding feature through the residual block, to acquire a twenty-second feature;
perform additive fusion on the second upsampled feature and the twenty-second feature, to acquire a twenty-third feature;
process the twenty-third feature through the residual block, to acquire the fifth decoding feature.

As an alternative embodiment of the present disclosure, the backward transfer module 83 is specifically configured to:
upsample the fifth decoding feature, to acquire a fourth upsampled feature;
process the fourth encoding feature through the residual block, to acquire a twenty-fourth feature;
perform additive fusion on the fourth upsampled feature and the twenty-fourth feature, to acquire a twenty-fifth feature;
process the twenty-fifth feature through the residual block, to acquire the fourth decoding feature.

As an alternative embodiment of the present disclosure, the feature fusion module 84 is specifically configured to:
fuse the intrinsic feature, the first encoding feature, the fourth encoding feature, the first decoding feature and the fourth decoding feature, to acquire a twenty-sixth feature;
fuse the twenty-sixth feature, the second encoding feature, the fifth encoding feature, the second decoding feature and the fifth decoding feature, to acquire a twenty-seventh feature;
fuse the twenty-seventh feature, the third encoding feature, the sixth encoding feature, the third decoding feature and the sixth decoding feature, to acquire a twenty-eighth feature;
process the twenty-eighth feature through the convolutional layer, to acquire an enhanced feature of the target video frame.

As an alternative embodiment of the present disclosure, the feature fusion module 84 is specifically configured to:
process the intrinsic feature through the residual block, to acquire a first feature;
perform additive fusion on the first encoding feature and the fourth encoding feature, to acquire a first fusion feature;
process the first fusion feature through the convolutional layer, to acquire a first convolutional feature;
perform additive fusion on the first decoding feature and the fourth decoding feature, to acquire a second fusion feature;
process the second fusion feature through the convolutional layer, to acquire a second convolutional feature;
perform additive fusion on the first feature, the first convolutional feature, and the second convolutional feature, to acquire the twenty-sixth feature.

As an alternative embodiment of the present disclosure, the feature fusion module 84 is specifically configured to:
process the twenty-sixth feature through the residual block, to acquire a first residual feature;
perform additive fusion on the second encoding feature and the fifth encoding feature, to acquire a third fusion feature;
process the third fusion feature through the convolutional layer, to acquire a third convolutional feature;
upsample the third convolutional feature, to acquire a fifth upsampled feature;
perform additive fusion on the second decoding feature and the fifth decoding feature, to acquire a fourth fusion feature;
process the fourth fusion feature through the convolutional layer, to acquire a fourth convolutional feature;
upsample the fourth convolutional feature, to acquire a sixth upsampled feature;
perform additive fusion on the first residual feature, the fifth upsampled feature, and the sixth unsampled feature, to acquire the twenty-seventh feature.

As an alternative embodiment of the present disclosure, the feature fusion module 84 is specifically configured to:
process the twenty-seventh feature through the residual block, to acquire a second residual feature;
perform additive fusion on the third encoding feature and the sixth encoding feature, to acquire a fifth fusion feature;
process the fifth fusion feature through the convolutional layer, to acquire a fifth convolutional feature;
upsample the fifth convolutional feature, to acquire a seventh upsampled feature;
perform additive fusion on the third decoding feature and the sixth decoding feature, to acquire a sixth fusion feature;
process the sixth fusion feature through the convolutional layer, to acquire a sixth convolutional feature;
upsample the sixth convolutional feature, to acquire an eighth upsampled feature;
perform additive fusion on the second residual feature, the seventh upsampled feature, and the eighth unsampled feature, to acquire the twenty-eighth feature.

The blurry video repair apparatus provided by the embodiments can perform the blurry video repair method provided by the method embodiments as described above, with similar principle and technical effects, which will not be repeated here.

It should be noted that each of the above modules and/or units only belongs to a logical module classified according to the specific function it implements, instead of limiting its specific implementation manner, for example, it can be implemented in software, hardware, or a combination of software and hardware. In an actual implementation, each of the above modules and/or units may be implemented as separate physical entity, or may be implemented by a single entity (for example, a processor (CPU or DSP, etc.), an integrated circuit, etc.). In addition, the above-described modules and/or units are shown in the drawings in dash lines to indicate that such modules and/or units may actually not exist, the operations/functionalities that they implement can be implemented by the apparatus or a processing circuit itself.

Based on the same inventive concept, embodiments of the present disclosure further provide an electronic device. FIG. 9 is a structural schematic diagram of an electronic device provided by the embodiments of the present disclosure, as shown in FIG. 9, the electronic device provided by the embodiments comprises: a memory 901 and a processor 902, wherein the memory 901 is used for storing a computer program; the processor 902 is configured to, upon invoking the computer program, execute the blurry video restoration method provided by the above embodiments.

Based on the same inventive concept, embodiments of the present disclosure further provide a computer-readable storage medium, the computer-readable storage medium is stored with a computer program, the computer program, when executed by a processor, causes a computing device to realize the blurry video repair method provided by the embodiments.

Based on the same inventive concept, embodiments of the present disclosure further provide a computer program product, the computer program product, when running on a computer, causes a computing device to realize the blurry video repair method provided by the embodiments.

Based on the same inventive concept, embodiments of the present disclosure further provide a computer program, the computer program comprises program codes, which, when executed by a computer, cause the computer to realize the blurry video repair method provided by the embodiments.

It should be understood by those skilled in the art that embodiments of the present disclosure can be provided as method, system, or computer program product. Therefore, the present disclosure can take the form of an entirely hardware embodiment, an entirely software embodiment, or an embodiment combining software and hardware aspects. Moreover, the present disclosure may take the form of a computer program product embodied on one or more computer usable storage media having computer usable program codes embodied therein.

In the present disclosure, the processor may be a Central Processing Unit (CPU), may also be other general processors, Digital Signal Processor (DSP), application specific integrated circuits (ASIC), Field-Programmable Gate Array (FPGA) or other programmable logic devices, discrete gate or transistor logic devices, discrete hardware components, etc. The general processor can be a microprocessor, or the processor can be any conventional processor, etc.

In the present disclosure, the memory may include non-persistent memory, random access memory (RAM) and/or non-volatile memory in computer-readable media, such as read-only memory (ROM) or flash RAM. Memory can be an example of a computer-readable medium.

In the present disclosure, a computer-readable medium can include persistent and non-persistent, removable and non-removable storage media. The storage medium can store information by any method or technology, and the information can be computer-readable instructions, data structures, program modules or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassette tape, magnetic disk storage, or other magnetic storage or any other non-transmission medium, that can be used for storing any information accessible to a computing device. According to the definition in the context of the description, the computer-readable media does not include transitory media, such as modulated data signals and carrier waves.

Finally, it should be noted that: the above embodiments are only used to illustrate the technical solutions of the present disclosure, instead of limiting them; although the present disclosure has been described in detail with reference to the foregoing embodiments, those ordinary skilled in the art will understand that: it still can modify the technical solution described in each embodiment, or partially or all technical characteristics are equivalent replacement; and these modifications or substitutions are not made to the extent of the technical solution of the present disclosure without departing from the essence of the corresponding technical solution.

1-27. (canceled)

28. A blurry video repair method, comprising:
performing feature extraction on a target video frame of a video to be repaired, to acquire an intrinsic feature of the target video frame;
acquiring a forward hidden variable set of the target video frame based on the intrinsic feature and a first hidden variable set, wherein the first hidden variable set is the forward hidden variable set of a previous video frame of the target video frame;
acquiring a backward hidden variable set of the target video frame based on the intrinsic feature and a second hidden variable set, wherein the second hidden variable set is the backward hidden variable set of a next video frame of the target video frame;
acquiring an enhanced feature of the target video frame based on the intrinsic feature, the forward hidden variable set of the target video frame, and the backward hidden variable set of the target video frame; and
performing additive fusion on the enhanced feature of the target video frame and the target video frame, to acquire a deblurred video frame from the target video frame.

29. The method of claim 28, wherein, the performing feature extraction on a target video frame of a video to be repaired, to acquire an intrinsic feature of the target video frame, comprises:
processing the target video frame through a convolutional layer, to acquire a convolutional feature;
processing the convolutional feature through a residual block, to acquire the intrinsic feature of the target video frame.

30. The method of claim 28, wherein, the forward hidden variable set comprises:
an encoding feature and a decoding feature under a first scale, an encoding feature and a decoding feature under a second scale, and an encoding feature and a decoding feature under a third scale.

31. The method of claim 30, wherein, the acquiring a forward hidden variable set of the target video frame based on the intrinsic feature and a first hidden variable set, comprise:
based on the intrinsic feature, and the encoding feature and the decoding feature under the first scale included in the first hidden variable set, acquiring a first encoding feature for the target video frame under the first scale;
based on the first encoding feature, and the encoding feature and the decoding feature under the second scale included in the first hidden variable set, acquiring a second encoding feature for the target video frame under the second scale;
based on the second encoding feature, and the encoding feature and the decoding feature under the third scale included in the first hidden variable set, acquiring a third encoding feature for the target video frame under the third scale;
based on the third encoding feature, acquiring a third decoding feature of the target video frame under the third scale;
based on the third decoding feature, and the encoding feature under the second scale included in the first hidden variable set, acquiring a second decoding feature for the target video frame under the second scale;
based on the second decoding feature and the encoding feature under the first scale included in the first hidden variable set, acquire the first decoding feature of the target video frame under the first scale;
combining the first encoding feature, the second encoding feature, the third encoding feature, the first decoding feature, the second decoding feature and the third decoding feature to the forward hidden variable set of the target video frame.

32. The method of claim 31, wherein, based on the intrinsic feature, and the encoding feature and the decoding feature under the first scale included in the first hidden variable set, the acquiring a first encoding feature for the target video frame under the first scale, comprises:
processing the intrinsic feature through the residual block, to acquire a first feature;
processing the encoding feature under the first scale included in the first hidden variable set through the convolutional layer, to acquire a second feature;
processing the decoding feature under the first scale included in the first hidden variable set through the convolutional layer, to acquire a third feature;
performing additive fusion on the first feature, the second feature and the third feature, to acquire the first encoding feature, and/or
wherein, based on the first encoding feature, and the encoding feature and the decoding feature under the second scale included in the first hidden variable set, the acquiring a second encoding feature for the target video frame under the second scale, comprises:
downsampling the first encoding feature, to acquire a first downsampled feature;
processing the first downsampled feature through the residual block, to acquire a fourth feature;
processing the encoding feature under the second scale included in the first hidden variable set through the convolutional layer, to acquire a fifth feature;
processing the decoding feature under the second scale included in the first hidden variable set through the convolutional layer, to acquire a sixth feature;
performing additive fusion on the fourth feature, the fifth feature and the sixth feature, to acquire the second encoding feature, and/or
wherein, based on the second encoding feature, and the encoding feature and the decoding feature under the third scale included in the first hidden variable set, the acquiring a third encoding feature for the target video frame under the third scale, comprises:
downsampling the second encoding feature, to acquire a second downsampled feature.
processing the second downsampled feature through the residual block, to acquire a seventh feature.
processing the encoding feature under the third scale included in the first hidden variable set through the convolutional layer, to acquire an eighth feature.
processing the decoding feature under the second scale included in the first hidden variable set through the convolutional layer, to acquire a ninth feature.
performing additive fusion on the seventh feature, the eighth feature and the ninth feature, to acquire the third encoding feature, and/or
based on the third encoding feature, the acquiring a third decoding feature of the target video frame under the third scale, comprises:
processing the third encoding feature through the residual block, to acquire the third decoding feature, and/or
wherein, based on the third decoding feature, and the encoding feature under the second scale included in the first hidden variable set, the acquiring a second decoding feature for the target video frame under the second scale, comprises:
upsampling the third decoding feature, to acquire a first upsampled feature.
processing the second encoding feature through the residual block, to acquire a tenth feature.
performing additive fusion on the first upsampled feature and the tenth feature, to acquire an eleventh feature.
processing the eleventh feature through the residual block, to acquire the second decoding feature, and/or
wherein, based on the second decoding feature and the encoding feature under the first scale included in the first hidden variable set, the acquiring the first decoding feature of the target video frame under the first scale, comprises:
upsampling the second decoding feature, to acquire a second upsampled feature;
processing the first encoding feature through the residual block, to acquire a twelfth feature;
performing additive fusion on the second upsampled feature and the twelfth feature, to acquire a thirteenth feature;
processing the thirteenth feature through the residual block, to acquire the first decoding feature.

33. The method of claim 28, wherein, the backward hidden variable set comprises:
an encoding feature and a decoding feature under a first scale, an encoding feature and a decoding feature under a second scale, and an encoding feature and a decoding feature under a third scale.

34. The method of claim 33, wherein, the acquiring a backward hidden variable set of the target video frame based on the intrinsic feature and a second hidden variable set, comprises:
based on the intrinsic feature, and the encoding feature and the decoding feature under the first scale included in the second hidden variable set, acquiring a fourth encoding feature for the target video frame under the first scale;
based on the fourth encoding feature, and the encoding feature and the decoding feature under the second scale included in the second hidden variable set, acquiring a fifth encoding feature for the target video frame under the second scale;
based on the fifth encoding feature, and the encoding feature and the decoding feature under the third scale included in the second hidden variable set, acquiring a sixth encoding feature for the target video frame under the third scale;
based on the sixth encoding feature, acquiring a sixth decoding feature of the target video frame under the third scale;
based on the sixth decoding feature, and the encoding feature under the second scale included in the second hidden variable set, acquiring a fifth decoding feature for the target video frame under the second scale;
based on the fifth decoding feature and the encoding feature under the first scale included in the second hidden variable set, acquiring the fourth decoding feature of the target video frame under the first scale;
combing the fourth encoding feature, the fifth encoding feature, the sixth encoding feature, the fourth decoding feature, the fifth decoding feature and the sixth decoding feature to the backward hidden variable set of the target video frame.

35. The method of claim 34, wherein, based on the intrinsic feature, and the encoding feature and the decoding feature under the first scale included in the second hidden variable set, the acquiring a fourth encoding feature for the target video frame under the first scale, comprises:
processing the intrinsic feature through the residual block, to acquire a first feature;
processing the encoding feature under the first scale included in the second hidden variable set through the convolutional layer, to acquire a fourteenth feature;
processing the decoding feature under the first scale included in the second hidden variable set through the convolutional layer, to acquire a fifteenth feature;
performing additive fusion on the first feature, the fourteenth feature and the fifteenth feature, to acquire the fourth encoding feature, and/or
wherein, based on the fourth encoding feature, and the encoding feature and the decoding feature under the second scale included in the second hidden variable set, the acquiring a fifth encoding feature for the target video frame under the second scale, comprises:
downsampling the fourth encoding feature, to acquire a third downsampled feature;
processing the third downsampled feature through the residual block, to acquire a sixteenth feature;
processing the encoding feature under the second scale included in the second hidden variable set through the convolutional layer, to acquire a seventeenth feature;
processing the decoding feature under the second scale included in the second hidden variable set through the convolutional layer, to acquire an eighteenth feature;
performing additive fusion on the sixteenth feature, the seventeenth feature and the eighteenth feature, to acquire the fifth encoding feature, and/or
wherein, based on the fifth encoding feature, and the encoding feature and the decoding feature under the third scale included in the second hidden variable set, the acquiring a sixth encoding feature for the target video frame under the third scale, comprises:
downsampling the fifth encoding feature, to acquire a fourth downsampled feature;
processing the fourth downsampled feature through the residual block, to acquire a nineteenth feature;
processing the encoding feature under the third scale included in the second hidden variable set through the convolutional layer, to acquire a twentieth feature;
processing the decoding feature under the second scale included in the second hidden variable set through the convolutional layer, to acquire a twenty-first feature;
performing additive fusion on the nineteenth feature, the twentieth feature and the twenty-first feature, to acquire the sixth encoding feature, and/or
wherein, based on the sixth encoding feature, the acquiring a sixth decoding feature of the target video frame under the third scale, comprises:
processing the sixth encoding feature through the residual block, to acquire the sixth decoding feature, and/or
wherein, based on the sixth decoding feature, and the encoding feature under the second scale included in the second hidden variable set, the acquiring a fifth decoding feature for the target video frame under the second scale, comprises:
upsampling the sixth decoding feature, to acquire a third upsampled feature;
processing the fifth encoding feature through the residual block, to acquire a twenty-second feature;
performing additive fusion on the second upsampled feature and the twenty-second feature, to acquire a twenty-third feature;
processing the twenty-third feature through the residual block, to acquire the fifth decoding feature, and/or
wherein, based on the fifth decoding feature and the encoding feature under the first scale included in the second hidden variable set, the acquiring the fourth decoding feature of the target video frame under the first scale, comprises:
upsampling the fifth decoding feature, to acquire a fourth upsampled feature;
processing the fourth encoding feature through the residual block, to acquire a twenty-fourth feature;
performing additive fusion on the fourth upsampled feature and the twenty-fourth feature, to acquire a twenty-fifth feature;
processing the twenty-fifth feature through the residual block, to acquire the fourth decoding feature.

36. The method of claim 28, wherein, the acquiring an enhanced feature of the target video frame based on the intrinsic feature, the forward hidden variable set of the target video frame, and the backward hidden variable set of the target video frame, comprises:
fusing the intrinsic feature, the first encoding feature, the fourth encoding feature, the first decoding feature and the fourth decoding feature, to acquire a twenty-sixth feature;
fusing the twenty-sixth feature, the second encoding feature, the fifth encoding feature, the second decoding feature and the fifth decoding feature, to acquire a twenty-seventh feature;
fusing the twenty-seventh feature, the third encoding feature, the sixth encoding feature, the third decoding feature and the sixth decoding feature, to acquire a twenty-eighth feature;
processing the twenty-eighth feature through the convolutional layer, to acquire an enhanced feature of the target video frame.

37. The method of claim 36, wherein, the fusing the intrinsic feature, the first encoding feature, the fourth encoding feature, the first decoding feature and the fourth decoding feature, to acquire a twenty-sixth feature, comprises:
processing the intrinsic feature through the residual block, to acquire a first feature;
performing additive fusion on the first encoding feature and the fourth encoding feature, to acquire a first fusion feature;
processing the first fusion feature through the convolutional layer, to acquire a first convolutional feature;
performing additive fusion on the first decoding feature and the fourth decoding feature, to acquire a second fusion feature;
processing the second fusion feature through the convolutional layer, to acquire a second convolutional feature;
performing additive fusion on the first feature, the first convolutional feature, and the second convolutional feature, to acquire the twenty-sixth feature, and/or
wherein, the fusing the twenty-sixth feature, the second encoding feature, the fifth encoding feature, the second decoding feature and the fifth decoding feature, to acquire a twenty-seventh feature, comprises:
processing the twenty-sixth feature through the residual block, to acquire a first residual feature;
performing additive fusion on the second encoding feature and the fifth encoding feature, to acquire a third fusion feature;
processing the third fusion feature through the convolutional layer, to acquire a third convolutional feature;
upsampling the third convolutional feature, to acquire a fifth upsampled feature;
performing additive fusion on the second decoding feature and the fifth decoding feature, to acquire a fourth fusion feature;
processing the fourth fusion feature through the convolutional layer, to acquire a fourth convolutional feature;
upsampling the fourth convolutional feature, to acquire a sixth upsampled feature;
performing additive fusion on the first residual feature, the fifth upsampled feature, and the sixth unsampled feature, to acquire the twenty-seventh feature, and/or
wherein, the fusing the twenty-seventh feature, the third encoding feature, the sixth encoding feature, the third decoding feature and the sixth decoding feature, to acquire a twenty-eighth feature, comprises:
processing the twenty-seventh feature through the residual block, to acquire a second residual feature;
performing additive fusion on the third encoding feature and the sixth encoding feature, to acquire a fifth fusion feature;
processing the fifth fusion feature through the convolutional layer, to acquire a fifth convolutional feature;
upsampling the fifth convolutional feature, to acquire a seventh upsampled feature;
performing additive fusion on the third decoding feature and the sixth decoding feature, to acquire a sixth fusion feature;
processing the sixth fusion feature through the convolutional layer, to acquire a sixth convolutional feature;
upsampling the sixth convolutional feature, to acquire an eighth upsampled feature;
performing additive fusion on the second residual feature, the seventh upsampled feature, and the eighth unsampled feature, to acquire the twenty-eighth feature.

38. An electronic device, comprising:
a processor; and
a memory for storing computer programs;
wherein the processor is used for, upon reading the computer programs from the memory, causes the electronic device to implement:
performing feature extraction on a target video frame of a video to be repaired, to acquire an intrinsic feature of the target video frame;
acquiring a forward hidden variable set of the target video frame based on the intrinsic feature and a first hidden variable set, wherein the first hidden variable set is the forward hidden variable set of a previous video frame of the target video frame;
acquiring a backward hidden variable set of the target video frame based on the intrinsic feature and a second hidden variable set, wherein the second hidden variable set is the backward hidden variable set of a next video frame of the target video frame;
acquiring an enhanced feature of the target video frame based on the intrinsic feature, the forward hidden variable set of the target video frame, and the backward hidden variable set of the target video frame; and
performing additive fusion on the enhanced feature of the target video frame and the target video frame, to acquire a deblurred video frame from the target video frame.

39. A non-transitory computer-readable storage medium storing computer programs, wherein the computer programs, when executed by a computing device, cause the computing device to implement:
performing feature extraction on a target video frame of a video to be repaired, to acquire an intrinsic feature of the target video frame;
acquiring a forward hidden variable set of the target video frame based on the intrinsic feature and a first hidden variable set, wherein the first hidden variable set is the forward hidden variable set of a previous video frame of the target video frame;
acquiring a backward hidden variable set of the target video frame based on the intrinsic feature and a second hidden variable set, wherein the second hidden variable set is the backward hidden variable set of a next video frame of the target video frame;
acquiring an enhanced feature of the target video frame based on the intrinsic feature, the forward hidden variable set of the target video frame, and the backward hidden variable set of the target video frame; and
performing additive fusion on the enhanced feature of the target video frame and the target video frame, to acquire a deblurred video frame from the target video frame.

40. The electronic device of claim 38, wherein, the performing feature extraction on a target video frame of a video to be repaired, to acquire an intrinsic feature of the target video frame, comprises:
processing the target video frame through a convolutional layer, to acquire a convolutional feature;
processing the convolutional feature through a residual block, to acquire the intrinsic feature of the target video frame.

41. The electronic device of claim 38, wherein, the forward hidden variable set comprises an encoding feature and a decoding feature under a first scale, an encoding feature and a decoding feature under a second scale, and an encoding feature and a decoding feature under a third scale,
wherein, the acquiring a forward hidden variable set of the target video frame based on the intrinsic feature and a first hidden variable set, comprise:
based on the intrinsic feature, and the encoding feature and the decoding feature under the first scale included in the first hidden variable set, acquiring a first encoding feature for the target video frame under the first scale;
based on the first encoding feature, and the encoding feature and the decoding feature under the second scale included in the first hidden variable set, acquiring a second encoding feature for the target video frame under the second scale;
based on the second encoding feature, and the encoding feature and the decoding feature under the third scale included in the first hidden variable set, acquiring a third encoding feature for the target video frame under the third scale;
based on the third encoding feature, acquiring a third decoding feature of the target video frame under the third scale;
based on the third decoding feature, and the encoding feature under the second scale included in the first hidden variable set, acquiring a second decoding feature for the target video frame under the second scale;
based on the second decoding feature and the encoding feature under the first scale included in the first hidden variable set, acquire the first decoding feature of the target video frame under the first scale;
combining the first encoding feature, the second encoding feature, the third encoding feature, the first decoding feature, the second decoding feature and the third decoding feature to the forward hidden variable set of the target video frame.

42. The electronic device of claim 38, wherein, the backward hidden variable set comprises an encoding feature and a decoding feature under a first scale, an encoding feature and a decoding feature under a second scale, and an encoding feature and a decoding feature under a third scale,
wherein, the acquiring a backward hidden variable set of the target video frame based on the intrinsic feature and a second hidden variable set, comprises:
based on the intrinsic feature, and the encoding feature and the decoding feature under the first scale included in the second hidden variable set, acquiring a fourth encoding feature for the target video frame under the first scale;
based on the fourth encoding feature, and the encoding feature and the decoding feature under the second scale included in the second hidden variable set, acquiring a fifth encoding feature for the target video frame under the second scale;
based on the fifth encoding feature, and the encoding feature and the decoding feature under the third scale included in the second hidden variable set, acquiring a sixth encoding feature for the target video frame under the third scale;
based on the sixth encoding feature, acquiring a sixth decoding feature of the target video frame under the third scale;
based on the sixth decoding feature, and the encoding feature under the second scale included in the second hidden variable set, acquiring a fifth decoding feature for the target video frame under the second scale;
based on the fifth decoding feature and the encoding feature under the first scale included in the second hidden variable set, acquiring the fourth decoding feature of the target video frame under the first scale;
combing the fourth encoding feature, the fifth encoding feature, the sixth encoding feature, the fourth decoding feature, the fifth decoding feature and the sixth decoding feature to the backward hidden variable set of the target video frame.

43. The electronic device of claim 38, wherein, the acquiring an enhanced feature of the target video frame based on the intrinsic feature, the forward hidden variable set of the target video frame, and the backward hidden variable set of the target video frame, comprises:
fusing the intrinsic feature, the first encoding feature, the fourth encoding feature, the first decoding feature and the fourth decoding feature, to acquire a twenty-sixth feature;
fusing the twenty-sixth feature, the second encoding feature, the fifth encoding feature, the second decoding feature and the fifth decoding feature, to acquire a twenty-seventh feature;
fusing the twenty-seventh feature, the third encoding feature, the sixth encoding feature, the third decoding feature and the sixth decoding feature, to acquire a twenty-eighth feature;
processing the twenty-eighth feature through the convolutional layer, to acquire an enhanced feature of the target video frame.

44. The non-transitory computer-readable storage medium of claim 39, wherein, the performing feature extraction on a target video frame of a video to be repaired, to acquire an intrinsic feature of the target video frame, comprises:
processing the target video frame through a convolutional layer, to acquire a convolutional feature;
processing the convolutional feature through a residual block, to acquire the intrinsic feature of the target video frame.

45. The non-transitory computer-readable storage medium of claim 39, wherein, the forward hidden variable set comprises an encoding feature and a decoding feature under a first scale, an encoding feature and a decoding feature under a second scale, and an encoding feature and a decoding feature under a third scale,
wherein, the acquiring a forward hidden variable set of the target video frame based on the intrinsic feature and a first hidden variable set, comprise:
based on the intrinsic feature, and the encoding feature and the decoding feature under the first scale included in the first hidden variable set, acquiring a first encoding feature for the target video frame under the first scale;
based on the first encoding feature, and the encoding feature and the decoding feature under the second scale included in the first hidden variable set, acquiring a second encoding feature for the target video frame under the second scale;
based on the second encoding feature, and the encoding feature and the decoding feature under the third scale included in the first hidden variable set, acquiring a third encoding feature for the target video frame under the third scale;
based on the third encoding feature, acquiring a third decoding feature of the target video frame under the third scale;
based on the third decoding feature, and the encoding feature under the second scale included in the first hidden variable set, acquiring a second decoding feature for the target video frame under the second scale;
based on the second decoding feature and the encoding feature under the first scale included in the first hidden variable set, acquire the first decoding feature of the target video frame under the first scale;
combining the first encoding feature, the second encoding feature, the third encoding feature, the first decoding feature, the second decoding feature and the third decoding feature to the forward hidden variable set of the target video frame.

46. The non-transitory computer-readable storage medium of claim 39, wherein, the backward hidden variable set comprises an encoding feature and a decoding feature under a first scale, an encoding feature and a decoding feature under a second scale, and an encoding feature and a decoding feature under a third scale,
wherein, the acquiring a backward hidden variable set of the target video frame based on the intrinsic feature and a second hidden variable set, comprises:
based on the intrinsic feature, and the encoding feature and the decoding feature under the first scale included in the second hidden variable set, acquiring a fourth encoding feature for the target video frame under the first scale;
based on the fourth encoding feature, and the encoding feature and the decoding feature under the second scale included in the second hidden variable set, acquiring a fifth encoding feature for the target video frame under the second scale;
based on the fifth encoding feature, and the encoding feature and the decoding feature under the third scale included in the second hidden variable set, acquiring a sixth encoding feature for the target video frame under the third scale;
based on the sixth encoding feature, acquiring a sixth decoding feature of the target video frame under the third scale;
based on the sixth decoding feature, and the encoding feature under the second scale included in the second hidden variable set, acquiring a fifth decoding feature for the target video frame under the second scale;
based on the fifth decoding feature and the encoding feature under the first scale included in the second hidden variable set, acquiring the fourth decoding feature of the target video frame under the first scale;
combing the fourth encoding feature, the fifth encoding feature, the sixth encoding feature, the fourth decoding feature, the fifth decoding feature and the sixth decoding feature to the backward hidden variable set of the target video frame.

47. The non-transitory computer-readable storage medium of claim 39, wherein, the acquiring an enhanced feature of the target video frame based on the intrinsic feature, the forward hidden variable set of the target video frame, and the backward hidden variable set of the target video frame, comprises:
fusing the intrinsic feature, the first encoding feature, the fourth encoding feature, the first decoding feature and the fourth decoding feature, to acquire a twenty-sixth feature;
fusing the twenty-sixth feature, the second encoding feature, the fifth encoding feature, the second decoding feature and the fifth decoding feature, to acquire a twenty-seventh feature;
fusing the twenty-seventh feature, the third encoding feature, the sixth encoding feature, the third decoding feature and the sixth decoding feature, to acquire a twenty-eighth feature;
processing the twenty-eighth feature through the convolutional layer, to acquire an enhanced feature of the target video frame.
